(19) United States
(12) Patent Application Publication
(10) Pub. No.: US 2023/0384542 A1
(43) Pub. Date: Nov. 30, 2023

(54) OPTICAL CONNECTING STRUCTURE, OPTICAL MODULE AND MANUFACTURING METHOD FOR OPTICAL CONNECTING STRUCTURE

(71) Applicant: Nippon Telegraph and Telephone Corporation, Tokyo (JP)

(72) Inventors: Yohei Saito, Tokyo (JP); Kota Shikama, Tokyo (JP); Norio Sato, Tokyo (JP)

(21) Appl. No.: 18/031,859

(22) PCT Filed: Nov. 12, 2020
(86) PCT No.: PCT/JP2020/042264

§ 371 Date: Apr. 13, 2023

(51) Int. Cl. G02B 6/42

(52) U.S. Cl. CPC G02B 6/4243; G02B 6/4213

(57) ABSTRACT

An optical connection structure includes an optical waveguide device that includes a substrate, a BOX layer, a first waveguide, and an overcladding in this order, an optical fiber disposed in a V-groove formed in the substrate, a self-forming waveguide disposed between an end face of the optical waveguide device and an end face of the optical fiber, and a cladding disposed around the self-forming waveguide. The optical fiber is positioned so that the end face of the optical fiber faces the end face of the optical waveguide device to cause signal light emitted from the optical fiber to enter the waveguide. The self-forming waveguide is formed with a portion cured by irradiation with resin curing light.

### CROSS-REFERENCE TO RELATED APPLICATIONS

This patent application is a national phase filing under section 371 of PCT application no. PCT/JP2020/042264, filed on Nov. 12, 2020, which application is incorporated herein by reference in its entirety.

### TECHNICAL FIELD

The present invention relates to an optical connection structure for connecting an optical fiber and a photonic device, an optical module, and a method for manufacturing the optical connection structure.

### BACKGROUND

Silicon photonics (SiPh) by which smaller optical devices than before can be manufactured has attracted attention in increasing the capacity of a network and reducing the space in a data center.

In recent years, to simplify the SiPh optical connection that requires highly accurate positioning, attention has been drawn to a method by which a V-groove is formed in the Si substrate of a chip, and an optical fiber is disposed on an end face of the SiPh chip, with the structure of the optical fiber serving as a positioning structure (Non Patent Literature 1). This method is a processing technique taking advantage of the fact that, when an Si substrate is subjected to etching with an alkaline liquid such as KOH, a shape determined by the crystal orientation is obtained. By this method, a V-groove for positioning an optical fiber can be integrally formed in a Si substrate with an accuracy of lithography.

By this method, it is possible to omit the active alignment for aligning an optical fiber array while monitoring the light coupling efficiency in a large-size alignment device, which is necessary in connecting a conventional chip and an optical fiber. Therefore, the present technology can be expected to lower costs and the like through simplification of the process for optical connecting portions.

### CITATION LIST

### Non Patent Literature

Non Patent Literature 1: S. Fathololoumi, et al. “1.6 Tbps Silicon Photonics Integrated Circuit for Co-Packaged Optical-IO Switch Applications.” Optical Fiber Communication Conference. Optical Society of America, 2020.

### SUMMARY

### Technical Problem

However, the above technique has the problems described below, due to the etching method. Normally, to optically connect an optical fiber and an end face of a chip, and cause light to propagate in the respective cores with low loss, it is necessary to bring the cores into contact with each other while positioning the respective cores with precision.

On the other hand, in a case where a V-groove is formed in a Si substrate by the above-described wet etching, such as a case where a V-groove is formed in the <110> direction (the X direction in the drawing) of a Si (001) substrate, not only an etching surface (hereinafter referred to as a “sloped etching surface”) A 610a having an inclination angle is formed on a side surface thereof, but also a similar sloped etching surface B 610b is formed on a side surface in the <1-10> direction (the Y direction in the drawing), as illustrated in FIGS. 24A and 24B, for example. This inclination angle is an angle determined by the crystal orientation (this angle will be hereinafter referred to as the “etching angle”).

FIGS. 25 and 26 show a sectional side view and a sectional view taken along the line XXVI-XXVI′, respectively, of a structure in which an optical fiber is disposed in the above-described V-groove in a Si substrate. As illustrated in FIG. 25, since the etching surface is sloped, an end face of the optical fiber cannot be completely brought into close contact with an end face of the chip. As a result, a gap appears between the optical fiber and the Si waveguide layer, and therefore, a loss due to the gap occurs. To avoid this gap, an additional step of mechanically and chemically processing the chip with high precision is used. For example, regarding the slope of Si, it is necessary to carry out a step of cutting the slope by performing dicing in the depth direction of FIG. 25, or a step of cutting the sloped portion of Si by additional etching.

As described above, in the case of the conventional method, an additional step for bringing an optical fiber into contact is required, which causes problems such as increases in the manufacturing steps and costs, and a decrease caused in the yield of chips by chipping due to dicing or the like.

### Solution to Problem

To solve the above problems, an optical connection structure according to embodiments of the present invention includes: an optical waveguide device including a substrate, a BOX layer, a first waveguide, and an overcladding in this order; an optical fiber disposed in a V-groove formed in the substrate; a self-forming waveguide disposed between an end face of the optical waveguide device and an end face of the optical fiber; and a cladding disposed around the self-forming waveguide. The optical fiber is positioned so that the end face of the optical fiber faces the end face of the optical waveguide device, to cause signal light emitted from the optical fiber to enter the first waveguide. The self-forming waveguide is formed with a portion cured by irradiation with resin curing light.

Further, a method for manufacturing an optical connection structure according to embodiments of the present invention includes: the step of sequentially stacking a BOX layer and Si on a substrate; the step of processing the Si into a first waveguide; a step of forming an overcladding on the first waveguide; the step of forming a V-groove in the substrate; the step of disposing the material of a self-forming waveguide on an end face of an optical waveguide device; the step of disposing an optical fiber in the V-groove; the step of irradiating the material with resin curing light, to form the self-forming waveguide; and the step of forming a cladding around the self-forming waveguide.

### Advantageous Effects of Embodiments of the Invention

According to embodiments of the present invention, it is possible to provide an optical connection structure in which an optical fiber can be easily connected to an optical waveguide device or the like disposed on a substrate with low loss.

### BRIEF DESCRIPTION OF THE DRAWINGS

FIG. 1A is a sectional side view of an optical connection structure according to a first embodiment of the present invention.

FIG. 1B is an IB-IB′ cross-sectional view of the optical connection structure according to the first embodiment of the present invention.

FIG. 2 is a sectional side view of the optical connection structure according to the first embodiment of the present invention.

FIG. 3 is a top perspective view of the optical connection structure according to the first embodiment of the present invention.

FIG. 4 is a diagram for explaining a method for manufacturing the optical connection structure according to the first embodiment of the present invention.

FIG. 5 is a sectional side view of an optical connection structure according to a second embodiment of the present invention.

FIG. 6 is a VI-VI′ cross-sectional view of the optical connection structure according to the second embodiment of the present invention.

FIG. 7 is a top perspective view of the optical connection structure according to the second embodiment of the present invention.

FIG. 8 is a sectional side view of the optical connection structure according to the second embodiment of the present invention.

FIG. 9 is a light intensity distribution chart for explaining an operation of the optical connection structure according to the second embodiment of the present invention.

FIG. 10 is a top perspective view of the optical connection structure according to the second embodiment of the present invention.

FIG. 11 is a top perspective view of an example of the optical connection structure according to the second embodiment of the present invention.

FIG. 12 is a sectional side view of an example of the optical connection structure according to the second embodiment of the present invention.

FIG. 13 is a sectional side view of an optical connection structure according to a modification of the second embodiment of the present invention.

FIG. 14 is a sectional side view of an optical connection structure according to a modification of the second embodiment of the present invention.

FIG. 15 is a sectional side view of an optical connection structure according to a modification of the second embodiment of the present invention.

FIG. 16 is a sectional side view of an optical connection structure according to a modification of the second embodiment of the present invention.

FIG. 17 is a top perspective view of an optical connection structure according to a third embodiment of the present invention.

FIG. 18 is a top perspective view of an optical connection structure according to a fourth embodiment of the present invention.

FIG. 19 is a top perspective view of an optical connection structure according to a fifth embodiment of the present invention.

FIG. 20 is a top perspective view for explaining the optical connection structure according to the fifth embodiment of the present invention.

FIG. 21 is a top perspective view for explaining the optical connection structure according to the fifth embodiment of the present invention.

FIG. 22 is a top perspective view of an example of the optical connection structure according to the fifth embodiment of the present invention.

FIG. 23 is a top perspective view for explaining the optical connection structure according to the fifth embodiment of the present invention.

FIG. 24A is a top view for explaining a conventional optical connection structure.

FIG. 24B is a XXIVB-XXIVB′ cross-sectional view for explaining the conventional optical connection structure.

FIG. 25 is a sectional side view of a conventional optical connection structure.

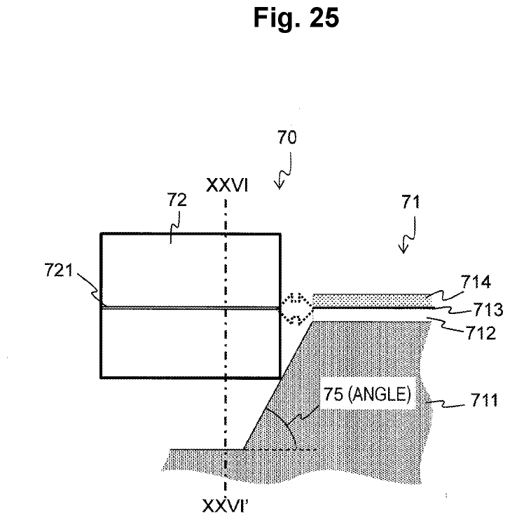

FIG. 26 is a XXVI-XXVI′ cross-sectional view of the conventional optical connection structure.

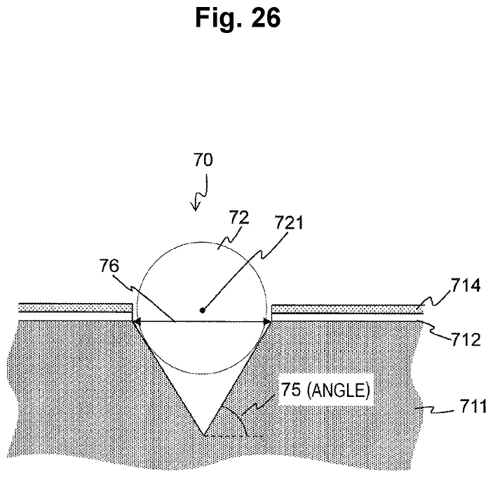

### DETAILED DESCRIPTION OF ILLUSTRATIVE EMBODIMENTS

### First Embodiment

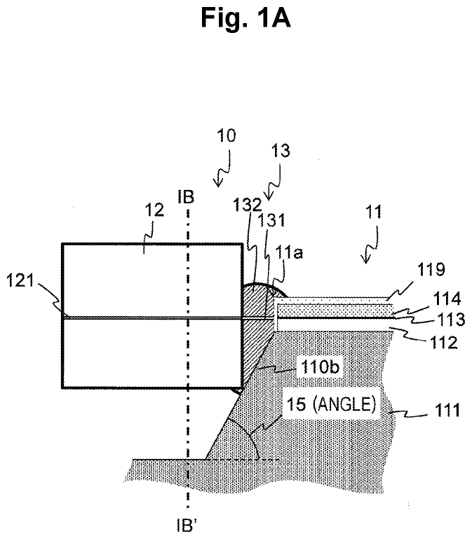

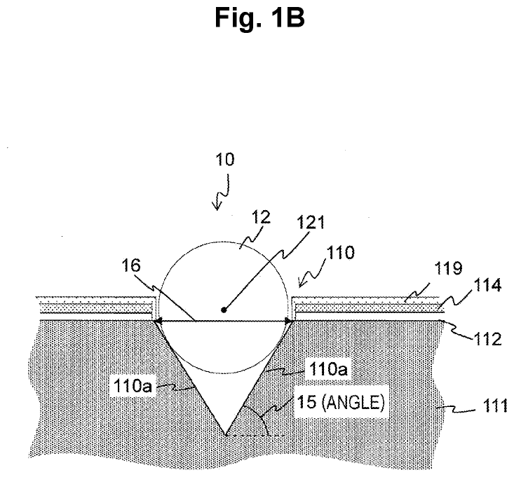

An optical connection structure according to a first embodiment of the present invention is described with reference to FIGS. 1A to 4.

### Configuration of an Optical Connection Structure

FIGS. 1A and 1B are cross-sectional schematic views of an optical connection structure 10 according to the first embodiment. FIG. 1A is a side view, and FIG. 1B is a cross-sectional view taken along the line IB-IB′.

The optical connection structure 10 includes an optical waveguide device 11, an optical fiber 12, and a self-forming waveguide connecting portion (hereinafter referred to as the “connecting portion”) 13.

The optical waveguide device 11 is a silicon photonic (SiPh) device, and includes a buried oxide (BOX) layer 112, a waveguide formed with Si as a first waveguide 113 (hereinafter referred to as the “Si waveguide”), and an overcladding 114, in this order on a Si substrate 111.

A groove 110 in which both sidewalls are sloped to form a V-shaped cross-section (hereinafter referred to as the “V-groove”) is formed in the Si substrate 111. Hereinafter, the direction of the edge line of the bottom of the V-groove 110 will be referred to as the “longitudinal direction of the V-groove”. The longitudinal direction of the V-groove is the <110> direction or the <1-10> direction in a case where a Si substrate having the (001) plane as its surface is used as the substrate.

As illustrated in FIG. 1B, the angle 15 formed by a sloping surface 110a of the V-groove 110 and the surface of the substrate 111 is 54.7°. Also, as illustrated in FIG. 1A, the angle 15 formed by a sloping surface 110b at the end of the groove 110 and the surface of the substrate 111 is 54.7°.

As illustrated in FIG. 1B, the optical fiber 12 is disposed in the V-groove 110 formed in the Si substrate 111. Also, as illustrated in FIG. 1A, the optical fiber 12 is disposed so that an end face thereof faces a surface 11a that is an end face of an optical waveguide device (a chip). As a result, when the optical connection structure 10 is operated as a device (or part of a device), signal light emitted from the optical fiber 12 enters the Si waveguide 113. Hereinafter, the end face of the optical waveguide device (chip) ii will refer to an end face of a layer including at least the BOX layer 112 and the overcladding 114 in the optical waveguide device 11 on the substrate 111.

Here, as will be described later, there are cases where a silicon nitride (SiNx) 119 that is used as a protective mask at the time of formation of the V-groove remains on the front surface and the end face of the optical waveguide device (chip) 11, as illustrated in FIG. 1A. In this case, the end face of the optical waveguide device (chip) 11 is the end face of the layer also including the silicon nitride (SiNx). Also, etching is gradually performed on this silicon nitride (SiNx) at the time of wet etching for the V-groove formation. This silicon nitride is removed depending on the etching conditions, and might not remain on the front surface and the end face of the optical waveguide device (chip) 11.

In the connecting portion 13, the self-forming waveguide 131 is formed between the optical waveguide device 11 and the optical fiber 12. In the self-forming waveguide 131, the portion having a refractive index changed by light irradiation is the self-forming waveguide (the core) 131.

Further, as a cladding 132 of the self-forming waveguide 131, a refractive index matching agent is applied between the optical fiber 12 and the optical waveguide device (chip) 11 so as to cover the self-forming waveguide 131. As a result, the cladding 132 is disposed around the self-forming waveguide 131.

Further, the refractive index matching agent 132 may have a refractive index so as to function as a cladding of the self-forming waveguide 131, and for example, an adhesive may be applied so that the refractive index matching agent 132 has a refractive index so as to function as a cladding when cured. As a result, stable connection characteristics can be maintained.

In the optical waveguide device 11, the width and the thickness of the Si waveguide 113 are 440 nm and 220 nm, respectively, the thickness of the BOX layer 112 is 3 μm, and the thickness of the portion of the overcladding 114 is about 4 μm, for example.

Also, a photocurable resin is often used as the material of the self-forming waveguide 131. However, formation of a self-forming waveguide with a bulk material such as crystal that causes a refractive index change through light irradiation, for example, has also been reported. As described above, if the self-forming waveguide is formed with a material that causes a refractive index change through light irradiation, the self-forming waveguide can be formed to achieve the same effects as above.

According to embodiments of the present invention, the optical fiber 12 and the end face of the optical waveguide device (chip) 11 can be connected by the self-forming waveguide 131, and thus, connection loss due to a gap can be reduced. Furthermore, the connection by the self-forming waveguide 131 does not require any additional processing of the chip 11 as described later. Thus, the influence of a gap can be easily reduced.

The self-forming waveguide technology is an optical connection technology using a photocurable resin. The self-forming waveguide technology is described below by taking a case where two optical waveguides are connected for example.

First, drops of a photocurable resin are put between two waveguides.

Next, the photocurable resin is irradiated with resin curing light that is light for curing the photocurable resin from one waveguide, so that a self-forming waveguide is formed in the portion irradiated with the light. At this point of time, cores are sequentially formed starting from the waveguide end face, to sequentially cure the resin starting from a portion having a high light intensity that is characteristic of a photocurable resin.

As a result, a self-forming waveguide is formed on the end face of the core without fail. According to the present technology, a waveguide that confines light can be formed between gaps (voids), and thus, waveguides having gaps can be connected with low loss.

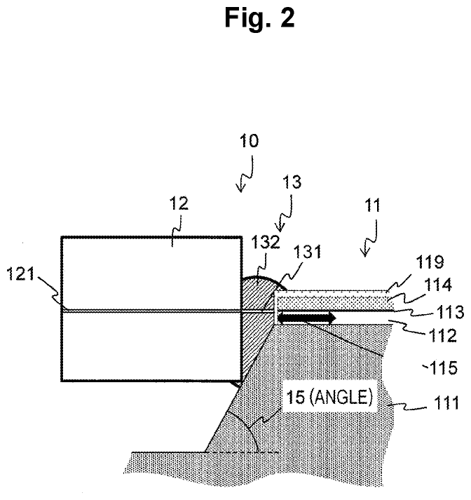

In manufacturing the self-forming waveguide 131, a mode field conversion unit 115 connected to the Si waveguide 113 may be disposed in a waveguide end vicinity portion including the waveguide end as illustrated in FIG. 2, and the shape of the Si waveguide 113 is not limited to any specific shape. In this case, the mode field diameter of light that can propagate in the chip 11 at the end of the chip 11 can be expanded by the mode field conversion unit 115, and thus, it is possible to match the mode field diameter in the optical fiber 12 and the self-forming waveguide 131 with that in the chip 11, and reduce the connection loss.

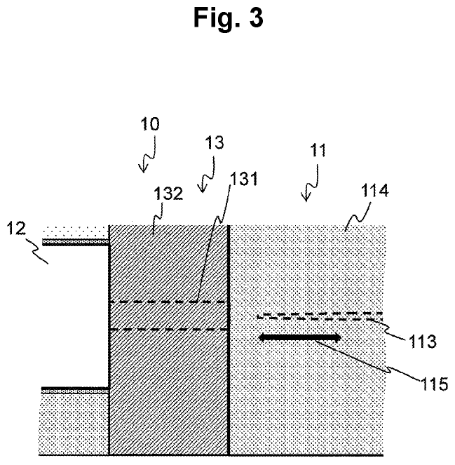

As illustrated in the top perspective view in FIG. 3, for example, the mode field conversion unit 115 can be formed with a tapered structure in which the width of the waveguide is narrower at a portion closer to the end of the chip 11. Note that, other than the structure illustrated in FIG. 3, the structure of the mode field conversion unit 115 can be formed with a structure divided into three parts or the like, for example. However, any known mode field conversion unit can perform the mode field conversion described in this embodiment.

### Method for Manufacturing the Optical Connection Structure 10

A method for manufacturing the optical connection structure 10 is described below.

First, the material of the BOX layer 112, such as silicon oxide, for example, is stacked on the Si substrate 111, and Si is stacked thereon.

Next, Si is processed into a waveguide by photolithography. At this stage, the Si in the portions other than the Si waveguide (first waveguide) 113 is removed.

Next, the overcladding 114 is formed with silicon oxide as the material, for example, on the Si waveguide (first waveguide) 113.

Next, formation of the V-groove 110 is performed. First, the silicon oxide (the overcladding 114 and the BOX layer 112) in the portion where the V-groove 110 is to be formed is removed by a conventional process.

Next, in the formation of the V-groove, a protective mask for protecting the Si waveguide 113 from an alkaline liquid (such as a KOH aqueous solution) to be used for anisotropic etching is formed with silicon nitride. For example, after silicon nitride (SiNx) is formed on the entire surface, the silicon nitride is processed so as to protect the portions other than the portion where the V-groove 110 is to be formed. Thus, a protective mask is produced.

Next, anisotropic etching is performed with a KOH aqueous solution, to form the V-groove 110. As a result of the step of forming the V-groove, the silicon nitride (SiNx) as the protective mask remains on the front surface and the end face of the optical waveguide device (chip) 11. Alternatively, etching is gradually performed on this silicon nitride (SiNx) at the time of wet etching for the V-groove formation. This silicon nitride is removed depending on the etching conditions, and might not remain on the front surface and the end face of the optical waveguide device (chip) 11.

At this stage, depending on the etching conditions, the end face of the chip 11 is also slightly affected by the etching, and the angle formed by the bottom surface and the end face of the chip 11 might have a structure having a slight inclination, instead of a perfect right angle as illustrated in FIG. 1A. However, at this stage, if the refractive index of the end face of the chip 11 is sufficiently close to the refractive index of the resin forming the self-forming waveguide 131, the influence of refraction is reduced. Therefore, the light beam emitted from the end face of the chip 11 travels substantially straight without being affected by the shape of the end face. At this stage, since the self-forming waveguide 131 formed by the resin curing light is formed substantially linearly, the shape of the end face formed by the etching does not greatly affect the operation of the optical connection structure 10 according to this embodiment.

This embodiment relates to an example in which the silicon oxide at the portion where the V-groove is to be formed is removed before the silicon nitride is formed on the surface, but this embodiment is not limited to this example. For example, after the silicon nitride protective mask is formed, the silicon oxide in the portion (the opening) where the V-groove is to be formed may be removed with an acid solution or by dry etching, and anisotropic etching may be performed on the Si with a KOH aqueous solution.

Next, optical connection is performed in the step of optical connection by the self-forming waveguide 131. First, drops of the material of the self-forming waveguide 131, such as a photocurable resin, for example, are put (disposed) on the end face of the optical waveguide device (chip) 11 and the V-groove in the surroundings.

Next, the optical fiber 12 is disposed, with the V-groove 110 serving as a positioning structure. At this stage, the optical fiber 12 is moved along the V-groove 110 until it comes into contact with the end face of the V-groove 110, so that the resin of the end face of the chip 11 can adhere to the end face of the optical fiber 12, and the space between the optical fiber 12 and the end face of the chip 11 can be filled with a photocurable resin.

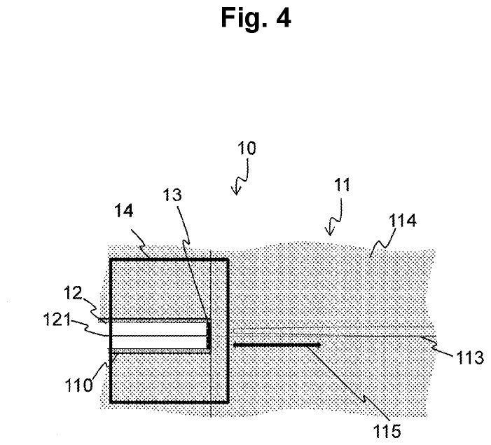

Note that, as can be seen from FIG. 1A, the sloping surface 110b of the Si substrate 110 may cause the optical fiber 12 to move onto an upper portion of the overcladding 114 when the optical fiber 12 is moved in a direction so as to come into contact with the optical waveguide device 11. Accordingly, as illustrated in FIG. 4, for example, a glass lid 14 is disposed on the optical fiber 12, and the optical fiber 12 is brought into contact with the optical waveguide device 11 while the optical fiber 12 is pushed from above. Thus, the optical fiber 12 can be prevented from moving onto the overcladding 114. At this stage, the length of the glass lid 14 may be set at an appropriate length.

Next, resin curing light is emitted from the optical fiber 12. Here, the entrance of the resin curing light into the optical fiber 12 can be easily realized with an optical connector or the like, for example. As a result, the photocurable resin is irradiated with the resin curing light, and is photocured. Thus, the self-forming waveguide 131 is formed.

Next, the uncured photocurable resin is washed away with a washing liquid such as ethanol.

Lastly, drops of the refractive index matching agent 132 are put around the self-forming waveguide 131, to form the cladding of the self-forming waveguide 131.

Alternatively, the self-forming waveguide 131 and the cladding around the self-forming waveguide 131 may be formed by the method described below. This formation method is substantially the same as the above-described manufacturing method, but differs in the resin to be used for forming the self-forming waveguide and the cladding thereof.

By this formation method, a plurality of (two in this embodiment) resins is mixed. The respective resins are cured by irradiation with light having different wavelengths, and have different refractive indexes after the curing.

Next, drops of the mixed resin are put (disposed) on the end face of the optical waveguide device (chip) 11 and into the V-groove in the surroundings.

After the position of the optical fiber 12 is adjusted, the portion of the self-forming waveguide 131 is then irradiated with resin curing light having one of the wavelengths from the end face of the optical fiber 12, and is cured.

Lastly, resin curing light having the other wavelength is emitted from the outside (mainly from above) of the dropped resin, to cure the uncured portion. Thus, the portion of the cladding (corresponding to the portion of the refractive index matching agent 132 in the above-described manufacturing method) is formed. The refractive index of this cladding portion is lower than the refractive index of the portion of the self-forming waveguide 131.

By this formation method, the self-forming waveguide 131 and the cladding 132 can be formed, without requiring the step of washing away the uncured photocurable resin.

In the above manner, the optical connection structure 10 according to this embodiment can be manufactured.

### Second Embodiment

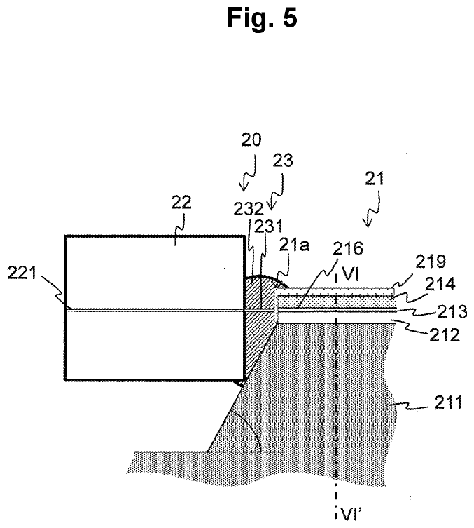

An optical connection structure according to a second embodiment of the present invention is described with reference to FIGS. 5 to 16.

### Configuration of an Optical Connection Structure 20

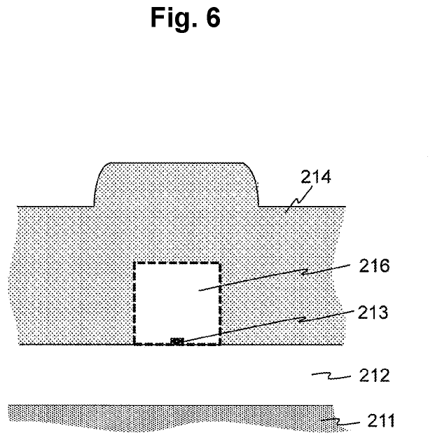

FIGS. 5 and 6 show cross-sectional schematic views of an optical connection structure 20 according to this embodiment. FIG. 5 is a side view, and FIG. 6 is a cross-sectional view taken along the line VI-VI′.

The optical connection structure 20 has substantially the same configuration as the optical connection structure 10 according to the first embodiment, but differs in that a second waveguide core 216 is formed so as to cover a Si waveguide (first waveguide) 213 as illustrated in FIG. 6. Specifically, the second waveguide core 216 is formed so as to cover the front surface and the side surface of the Si waveguide 213.

Hereinafter, the end face of an optical waveguide device (chip) 21 will refer to an end face of a layer including at least a BOX layer 212 and an overcladding 214 in the optical waveguide device 21 on a substrate 211.

Here, there are cases where a silicon nitride (SiNx) 219 that is used as a protective mask at the time of formation of a V-groove remains on the front surface and the end face of the optical waveguide device (chip) 21, as illustrated in FIG. 5. In this case, the end face of the optical waveguide device (chip) 21 is the end face of the layer also including the silicon nitride (SiNx) 219. Also, etching is gradually performed on the silicon nitride (SiNx) 219 at the time of wet etching for the V-groove formation. The silicon nitride 219 is removed depending on the etching conditions, and might not remain on the front surface and the end face of the optical waveguide device (chip) 21.

Further, a refractive index matching agent 232 is applied as a cladding between an optical fiber 22 and the chip 21 so as to cover a self-forming waveguide 231.

Further, examples of the respective dimensions are as follows: the width and the thickness of the second waveguide core 216 are both 3 μm, the width and the thickness of the Si waveguide 213 are 440 nm and 220 nm, respectively, the thickness of the buried oxide (BOX) layer 212 is 3 μm, and the thickness of the portion of the overcladding 214 is about 4 μm.

This embodiment differs from the first embodiment in that resin curing light is emitted not only from the optical fiber 22 but also from the end face of the optical waveguide device (chip) 21, to form the self-forming waveguide 231.

As a result, it is possible to achieve an effect that enables low-loss connection even if the self-forming waveguide 231 has not only a gap but also an optical axis deviation (a deviation of each core center in the depth direction of the paper surface in FIG. 5 or in a direction perpendicular to the surface of the substrate 211) between waveguides. Thus, even if a machining error occurs in the formed V-groove, and there is an optical axis deviation between the optical fiber 22 and the end face of the chip 21, connection can be performed with low loss.

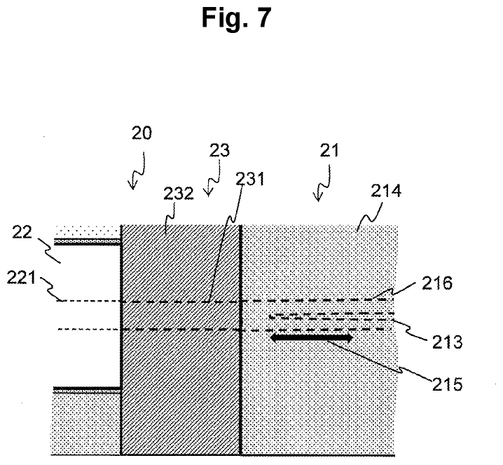

Further, a top perspective view of this connection structure is illustrated in FIG. 7. The Si waveguide 213 is connected to a mode field conversion unit having a structure that changes the mode field diameter of light, and can be formed with a waveguide having a shape whose width gradually decreases in a longitudinal direction, for example. At this stage, a mode field conversion unit 215 can have a length of about 300 μm, for example.

As for the material forming this structure, SiON produced by adding nitrogen to silicon oxide, or the like may be used as the second waveguide core 216, for example.

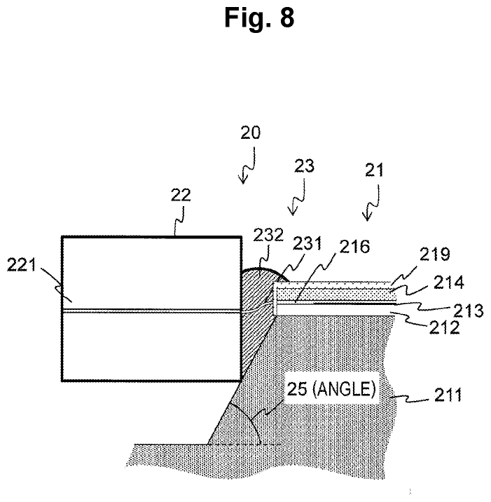

Further, as resin curing light is emitted from both the optical fiber 22 and the optical waveguide device (chip) 21, the self-forming waveguide 231 having a bent shape (S-shape) that compensates for an optical axis deviation is formed as illustrated in FIG. 8 in a case where the optical axis deviation occurs between the respective waveguides. Thus, connection can be performed with low loss.

The photocurable resin used in the self-forming waveguide technology is sequentially cured starting from the portion irradiated with high-intensity resin curing light. As a result, in a case where resin curing light is emitted from both the optical fiber 22 and the optical waveguide device (chip) 21 in this embodiment, the self-forming waveguide 231 having a bent (S-shaped) shape is formed so as to compensate for optical axis deviations even if the optical axis deviations are positional deviations of the optical fiber 22 in a direction perpendicular to the longitudinal direction of a V-groove 210 and in a direction perpendicular to the surface of the Si substrate 211 in the horizontal plane, for example. Accordingly, it is possible to perform low-loss optical connection even when there are optical axis deviations caused by a machining error of the V-groove 210 or the like.

In the description below, the resin curing light to be emitted from both the optical fiber 22 and the optical waveguide device (chip) 21 is described. The wavelength of the resin curing light is in the visible light region. Quartz, which is the principal material of the optical fiber 22, is transparent to visible light, and accordingly, visible light, which is resin curing light, can propagate in the optical fiber 22 with low loss.

On the other hand, a semiconductor-based waveguide formed with Si or the like has a high absorptivity in the visible light region, and therefore, it is difficult to obtain emission of resin curing light from the waveguide end face due to the material absorption loss. In view of this, a material transparent to visible light is used as a material of the second waveguide core 216 in this embodiment, so that optical connection is achieved with a self-forming waveguide.

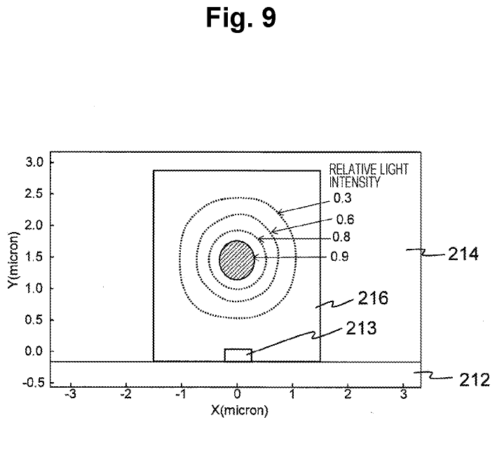

In this structure, visible light can propagate in the region of the second waveguide core 216 with a sufficiently low loss. FIG. 9 illustrates a result of numerical calculation of the normalized electric field amplitude of a propagation mode of this structure. As for the structure for the calculation, the Si waveguide 213, SiON as the second waveguide core 216, and silicon oxide as the overcladding 214 and the BOX layer 212 were used. MODE solutions of Lumerical were used for the calculation.

Also, the electric field amplitude is normalized with the maximum value of the electric field amplitude in this structure, and is indicated as a relative light intensity. A shaded area in FIG. 9 indicates the portion in which the relative light intensity is 0.9 or higher, and optical confinement is intensive. In this manner, with this structure, light can be confined and be made to propagate in the portion of the transparent second waveguide core 216.

Also, the structure of this embodiment in which the Si waveguide 213 is covered with the second waveguide core 216 is a structure that is generally used to cause light to adiabatically transition to cores having different cross-sectional areas, and includes waveguides having different mode fields, and the mode field conversion unit 215 that connects them with low loss.

In this structure, the core width is narrower at a portion closer to the tip of the mode field conversion unit 215, and accordingly, the optical confinement for the light confined in the Si waveguide 213 is weaker at a portion closer to the tip of the mode field conversion unit 215. Through a process in which the mode field gradually expands into the second waveguide core 216, the light enters a mode in which light propagates in the second waveguide core 216, and the light then actually propagates therein. Note that, other than the simple tapered structure in which the width is smaller at a portion closer to the end of the second waveguide core 216 as illustrated in FIG. 7, the mode field conversion unit 215 may have any structure such as a structure divided into three portions. However, embodiments of the present invention do not limit the shape thereof.

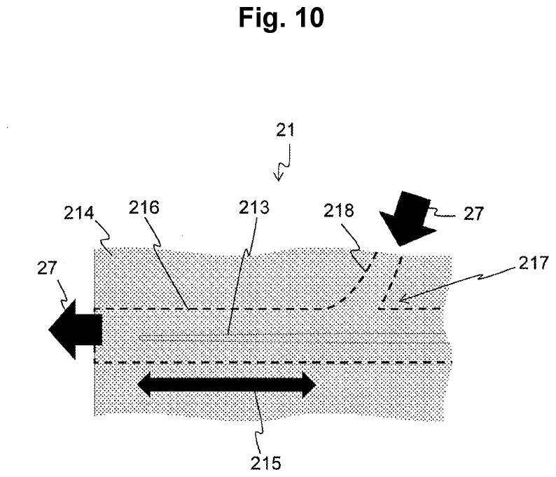

Further, to perform optical connection with a self-forming waveguide in this structure, resin curing light needs to be emitted from the end face of the second waveguide core 216. Therefore, as illustrated in FIG. 10, for example, a Y-branch structure 217 to be provided in the second waveguide core 216 is used. Resin curing light 27 propagates in a coupling waveguide 218, is coupled to the second waveguide core 216 by the Y-branch structure 217, propagates in the second waveguide core 216, and is emitted from the end face of the optical waveguide device 21. With this configuration, it is possible to obtain emission of the resin curing light 27 from the waveguide end face, which is essential for achieving an optical axis deviation compensation effect with the self-forming waveguide 231.

Here, in the second waveguide core 216 covering the Si waveguide 213, the Y-branch structure 217 is preferably formed in the portion of the second waveguide core 216 covering a region other than the mode field conversion unit 215. When signal light is input from the optical fiber 22 to the optical waveguide device 21, and is transmitted in the optical waveguide from the end face of the optical waveguide device 21, the signal light is sufficiently confined in the Si waveguide 213 after passing through the mode field conversion unit 215. As a result, the signal light confined in the Si waveguide 213 is hardly affected by the Y-branch structure 217, because the distance between the Si waveguide 213 and the Y-branch structure 217 is equal to or longer than the wavelength of the light. In this manner, it is possible to sufficiently suppress the influence of the Y-branch structure 217 on the mode field conversion effect in the transmission of the signal light.

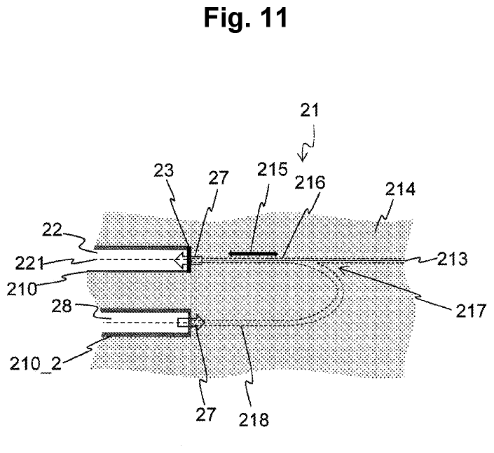

Further, to emit the resin curing light 27 in this structure, it is necessary to couple the resin curing light 27 from the outside of the optical waveguide device (chip) 21 to an optical waveguide on the Si substrate 211. Therefore, as illustrated in FIG. 11, for example, an optical fiber 28 for entrance of resin curing light is disposed in a V-groove 210_2. Here, the end face of the optical fiber 28 is positioned to face the end face of the optical waveguide device (chip) 21 so that the resin curing light 27 emitted from the optical fiber 28 enters (is coupled to) the coupling waveguide 218. In this manner, the optical fiber 22 and the resin-curing-light entering optical fiber 28 are disposed in the V-grooves 210 and 210_2, respectively, and the resin curing light 27 enters from the resin-curing-light entering optical fiber 28 and the optical fiber 22.

At this stage, as illustrated in FIG. 11, the light is made to propagate to the Y-branch structure 217 through the bent waveguide of the coupling waveguide 218, so that the resin curing light 27 can be emitted from the end face of the chip 21.

In this structure, a gap also exists between the end faces of the resin-curing-light entering optical fiber 28 and the chip 21. As a result, there also is a loss due to light diffraction when the resin curing light 27 enters. However, the light intensity per unit area of the resin curing light 27 necessary for the self-forming waveguide 231 is low, and, for example, about several tens of μW is sufficient for the thickness of 3 μm and the width of 3 μm of the second waveguide core 216. The output of a commercially available, and relatively inexpensive semiconductor laser in the wavelength band of the resin curing light 27 is several mW, which is sufficiently large. Thus, it is possible to secure a sufficient output for forming the self-forming waveguide 231 even if there is some loss. Note that, even if there is not a Y-branch, any technique is acceptable as long as light propagating in a known waveguide such as a multimode interference coupler or a directional coupler can be coupled to a desired waveguide.

### Method for Manufacturing the Optical Connection Structure 20

Next, a method for manufacturing this structure is described. First, the material of the BOX layer 212, such as silicon oxide, for example, is stacked on the Si substrate 211, and Si is stacked thereon.

Next, Si is processed into a waveguide by photolithography. At this stage, the Si in the portions other than the Si waveguide (first waveguide) 113 is removed.

Next, the material of the second waveguide core 216, such as SiON, for example, is stacked on the Si waveguide 213, so as to cover the Si waveguide 213.

Next, SiON is processed into a waveguide (the second waveguide core 216) by conventional photolithography. At this stage, SiON in the portions other than the second waveguide core 216 is removed.

Next, the overcladding 214 is formed with silicon oxide as the material, for example, on the second waveguide core 216, so as to cover the second waveguide core 216.

At this stage, the overcladding 214 stacked over the SiON waveguide has a protruding portion as illustrated in FIG. 6. Since it is difficult to form a protective film on the side surfaces of this protruding portion, a protective film can be formed after the protruding portion is polished to flatten the surface of the overcladding 214 by chemical mechanical polishing (CMP) or the like.

Next, formation of the V-grooves 210 and 210_2 is performed. First, the silicon oxide (the overcladding 214 and the BOX layer 212) in the portions where the V-grooves 210 and 210_2 are to be formed is removed by a conventional process.

Next, in the formation of the V-grooves, a protective mask for protecting the Si waveguide 213 and the second waveguide core 216 from an alkaline liquid (such as a KOH aqueous solution) to be used for anisotropic etching is formed with silicon nitride. For example, after silicon nitride (SiNx) is formed on the entire surface, the silicon nitride is processed so as to protect the portions other than the portions where the V-grooves 210 and 210_2 are to be formed. Thus, a protective mask is produced.

Next, anisotropic etching is performed with a KOH aqueous solution, to form the V-grooves 210 and 210_2. As a result of the step of forming the V-grooves, the silicon nitride (SiNx) as the protective mask remains on the front surface and the end face of the optical waveguide device (chip) 11. Alternatively, etching is gradually performed on this silicon nitride (SiNx) at the time of wet etching for the V-groove formation. This silicon nitride is removed depending on the etching conditions, and might not remain on the front surface and the end face of the optical waveguide device (chip) 11.

At this stage, since the self-forming waveguide 231 formed by the resin curing light 27 is formed substantially linearly, the shape of the end face formed by the etching does not greatly affect the operation of the optical connection structure 20 according to this embodiment.

This embodiment relates to an example in which the silicon oxide at the portions where the V-grooves are to be formed is removed before the silicon nitride is formed on the surface, but this embodiment is not limited to this example. For example, after the silicon nitride protective mask is formed, the silicon oxide in the portions (the openings) where the V-grooves are to be formed may be removed with an acid solution or by dry etching, and anisotropic etching may be performed on the Si with a KOH aqueous solution.

Next, optical connection is performed in the step of optical connection by the self-forming waveguide 231. First, drops of the material of the self-forming waveguide 231, such as a photocurable resin, for example, are put (disposed) on the end face of the second waveguide core 216 described above.

Next, the V-grooves 210 and 210_2 are used as positioning structures, and the optical fiber 22 and the resin-curing-light entering optical fiber 28 are disposed in the V-grooves 210 and 210_2, respectively. At this stage, the optical fiber 22 is moved along the V-groove 210 until it comes into contact with the end face of the V-groove 210, so that the resin of the end face of the chip 21 can adhere to the end face of the optical fiber 22, and the space between the optical fiber 22 and the end face of the chip 21 can be filled with a photocurable resin. At this stage, a glass lid or the like may be used as described above.

Next, the resin curing light 27 is emitted from the resin-curing-light entering optical fiber 28 and the optical fiber 22. As a result, the photocurable resin is irradiated with the resin curing light 27, and is photocured. Thus, the self-forming waveguide 231 is formed.

Next, the uncured photocurable resin is washed away with a washing liquid such as ethanol.

Lastly, drops of the refractive index matching agent 232 are put around the self-forming waveguide 231, to form the cladding portion of the self-forming waveguide 231. At this stage, the optical fiber 22 and the chip 21 may be bonded to each other with an adhesive having a refractive index that is almost the same as that of the resin for refractive index matching.

Here, the self-forming waveguide 231 and the cladding in its surroundings may be formed with a plurality of resins, without washing away the uncured photocurable resin, as in the first embodiment.

### Modifications of the Second Embodiment

An optical connection structure according to a modification of this embodiment is now described.

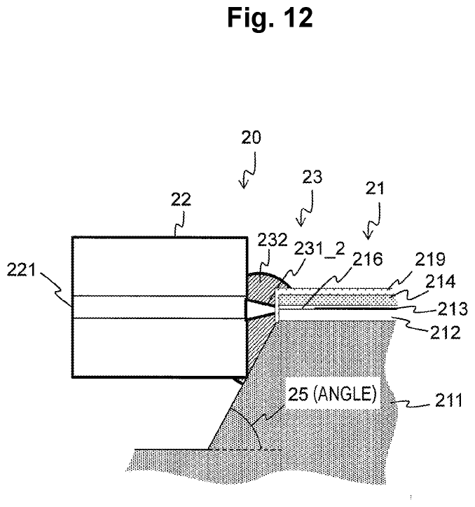

First, in this structure, a self-forming waveguide 231_2 as a waveguide only needs to confine light by a refractive index difference between the core and the cladding, and the shape thereof is not limited to any specific shape. For example, as illustrated in FIG. 12, a structure in which its cross-section gradually expands from the end face of the optical fiber 22 toward the end face of the chip 21 may be used. The self-forming waveguide 231_2 between waveguides having different core diameters has such a structure. In the case of this structure, it is possible to convert the mode field of light with the self-forming waveguide 231_2. As a result, it is possible to compensate for the connection loss caused by the difference in mode field between the core 221 of the optical fiber 22 and the core of the waveguide at the end face of the chip 21.

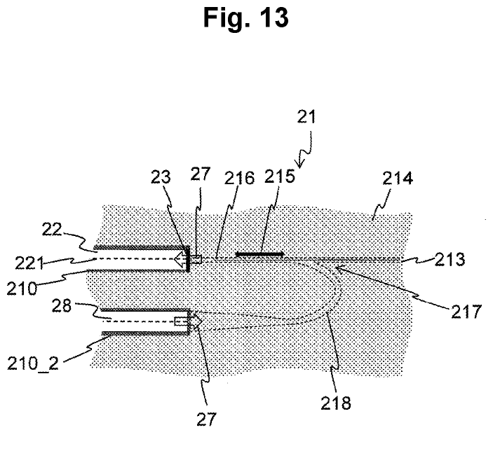

Also, as illustrated in FIG. 13, in the U-shaped coupling waveguide 218 for entering the self-forming waveguide 231, a tapered structure may be formed on the end face portion of the chip 21 through which the resin curing light 27 enters. Between the cores of the resin-curing-light entering optical fiber 28 and the coupling waveguide 218, there might be a difference in mode field diameter due to the sizes of the cores or the optical characteristics of the waveguide. By manufacturing the structure illustrated in FIG. 13, it is possible to expand the mode field diameter of the resin curing light 27 in the chip 21. Thus, the coupling efficiency of light from the resin-curing-light entering optical fiber 28 to the coupling waveguide 218 can be improved.

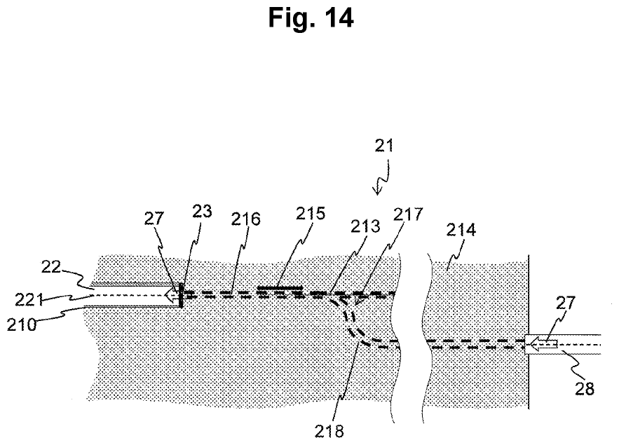

Further, as for the method for inputting the resin curing light 27, other than the method using the V-groove 210_2, the core of the optical fiber 22 may be directly adjusted to the end face of the chip 21 on the opposite side from the end face of the chip 21 in which the V-groove 210 for the optical fiber 22 is formed, and the resin curing light 27 may be made to enter the coupling waveguide 218 and be coupled to the second waveguide core 216 in the chip 21 as illustrated in FIG. 14.

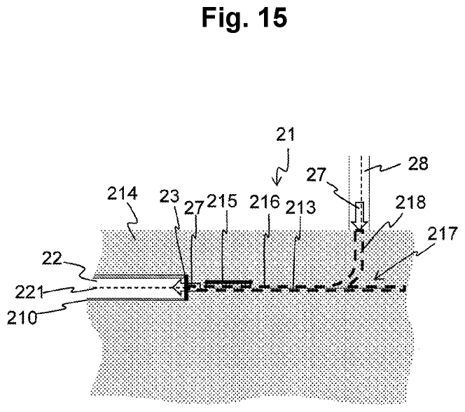

Alternatively, the resin curing light 27 may be made to enter from an end face other than the end face of the chip 21 on the opposite side from the end face of the chip 21 in which the V-groove 210 for the optical fiber 22 is formed. For example, as illustrated in FIG. 15, the resin curing light 27 may enter from the end face of the chip 21 on a side (substantially perpendicular to the end face of the optical waveguide device 21 facing the end face of the optical fiber 22). As the position from which the resin curing light 27 enters is formed in a portion other than the end face in which the V-groove 210 for the optical fiber 22 is formed, it becomes unnecessary to form the V-groove 210 for disposing the resin-curing-light entering optical fiber, and the connecting portion between the optical fiber 22 and the chip 21 can be made smaller in size.

Also, any known method can be applied as long as it is a method by which the optical fiber 22 is not connected from a side surface (an end face) of the optical waveguide device (chip) 21, but total reflection is caused at the interface between air and a waveguide by a diffraction grating coupler, a configuration in which the end face of the chip 21 is obliquely polished, or the like, and resin curing light can be made to enter from the upper surface of the chip.

Although the configuration in which the Si waveguide 213 is present in the second waveguide core 216 has been described as an example, any known form can also be adopted as long as the second waveguide core 216 and the Si waveguide 213 are adiabatically and optically coupled and function as a spot size converter. For example, a waveguide in which the second waveguide core 216 is disposed on the upper surface of the Si waveguide 213, or the like, may be formed so that the directions in which light propagates in the second waveguide core 216 and the Si waveguide 213 are substantially parallel to each other, and the second waveguide core 216 and the Si waveguide 213 are optically coupled.

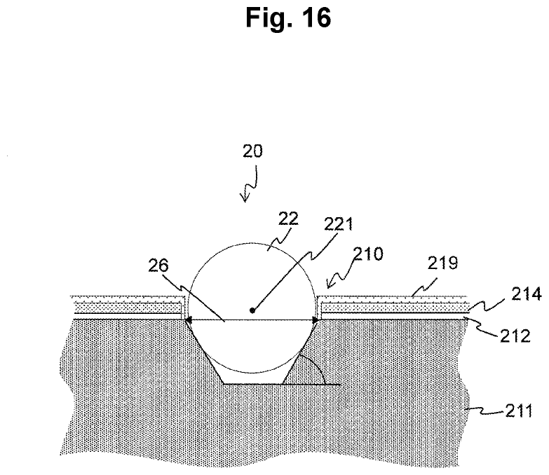

Further, as for the shape of the V-groove 210, there is a possibility that a structure illustrated in FIG. 16 is obtained if the anisotropic etching is stopped before the formation of the V-groove 210. Even in such a state, if the depth of the Si substrate 211 is sufficiently greater than the radius of the core 221 of the optical fiber 22, the V-groove 210 also functions as the positioning structure for the optical fiber 22, and embodiments of the present invention can also be applied. In an embodiment of the present invention, the V-groove may also be a groove having a shape formed with sloping surfaces on both sides and a bottom surface as illustrated in FIG. 16.

### Third Embodiment

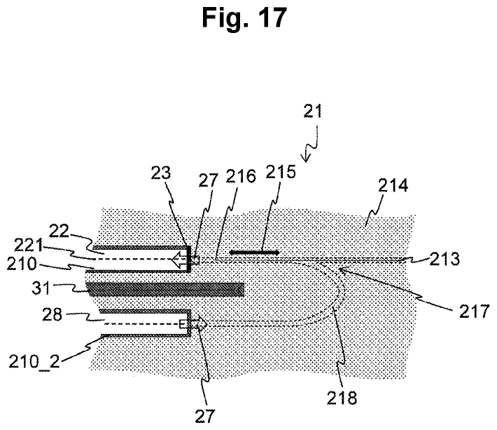

An optical connection structure according to a third embodiment of the present invention is described with reference to FIG. 17.

### Configuration of an Optical Connection Structure 30

FIG. 17 illustrates an optical connection structure 30 according to this embodiment.

The optical connection structure 30 further includes a groove portion (hereinafter referred to as the “resin intrusion preventing groove”) 31 between the V-groove 210 in which the optical fiber 22 is disposed and the V-groove 210_2 in which the resin-curing-light entering optical fiber 28 is disposed in the second embodiment.

In the second embodiment, the photocurable resin to be used for forming the self-forming waveguide 231 has a very high light absorptivity in the curing wavelength band.

Meanwhile, a curable resin is a liquid before curing. Therefore, when drops of a curable resin are disposed at the time of disposing the optical fiber 22 in the V-groove 210, the curable resin might enter the neighboring V-groove 210_2 in which the resin-curing-light entering optical fiber 28 is to be disposed.

In this case, when the curable resin enters between the resin-curing-light entering optical fiber 28 and the end face of the chip 21, the resin curing light 27 to enter the second waveguide core 216 from the resin-curing-light entering optical fiber 28 is subjected to an absorption loss due to the curable resin, and as a result, the output necessary for forming the self-forming waveguide 231 might not be obtained.

Therefore, in this embodiment, the groove portion (resin intrusion preventing groove) 31 that prevents intrusion of a curable resin in a liquid state is formed between the V-groove 210 in which the optical fiber 22 is to be disposed and the V-groove 210_2 in which the resin-curing-light entering optical fiber 28 is to be disposed. Because of the resin intrusion preventing groove 31, even when an excessive amount of drops of a curable resin are put on the end face of the chip 21, the curable resin flows into the groove portion. Thus, resin intrusion into the resin-curing-light entering optical fiber 28 can be prevented.

The resin intrusion preventing groove 31 can be formed by the same process as the process of forming the V-groove 210 in which the optical fiber 22 is to be disposed, for example. In this embodiment, as long as a groove is formed, embodiments of the present invention do not limit the method for forming the groove and the shape of the groove.

### Fourth Embodiment

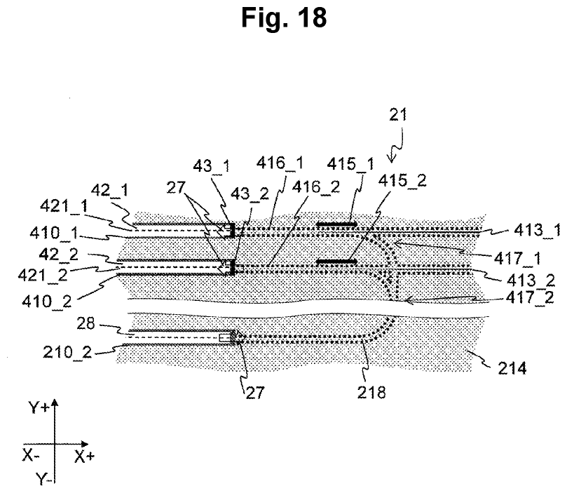

An optical connection structure according to a fourth embodiment of the present invention is described with reference to FIG. 18. An optical connection structure 40 according to this embodiment has substantially the same configuration and effects as those of the second embodiment, but differs in the aspects described below.

In the optical connection structure 40, optical power is branched with the use of an optical circuit structure, even though resin curing light is input from only one point. Thus, the resin curing light can be simultaneously emitted from the ends of a plurality of optical waveguides, and self-forming waveguides (SWW) can be simultaneously formed in the plurality of waveguides.

### Configuration of an Optical Connection Structure 40

FIG. 18 shows a top perspective view of the optical connection structure 40 according to this embodiment. Here, arrows in the drawing indicate positive and negative directions of the X-axis and the Y-axis.

The optical connection structure 40 includes an optical waveguide including a plurality of (two in this embodiment) Si waveguides 413_1 and 413_2, second waveguide cores 416_1 and 416_2, and mode field conversion units 415_1 and 415_2. Further, a plurality of optical fibers 42_1 and 42_2 is disposed in V-grooves 410_1 and 410_2 so that the end faces thereof face the end faces of the respective optical waveguides, and connecting portions 43_1 and 43_2 are disposed between the respective optical waveguides and the optical fibers 42_1 and 42_2. Further, the coupling waveguide 218 coupled to the resin-curing-light inputting optical fiber 28 disposed in the V-groove 210_2 is branched and connected to each of the plurality of optical waveguides.

In the optical connection structure 40, the resin curing light 27 input from the resin-curing-light inputting optical fiber 28 to the coupling waveguides 218 is first branched by a branch structure 417_2. One of the branched light beams is coupled to the second waveguide core 416_2 from the X-side coupling waveguide 218 of the two coupling waveguides 218, propagates in the X− direction, and is emitted from the end face of the optical waveguide.

The other light beam passes through the branch structure 417_2, then propagates in the Y+ direction in the coupling waveguide 218, and reaches the crossover structure in which the coupling waveguide 218 and the second waveguide core 416_2 cross each other. In this crossover structure, the coupling waveguide 218 is connected to the second waveguide core 416_2 above the Si waveguide 413_2. In this crossover structure, excessive loss occurs due to diffraction or Si influence in the crossover structure. However, since the light required for optical connection with a self-forming waveguide may be weak as described above, a small loss does not lead to great influence.

After passing through this crossover structure, the resin curing light 27 further propagates in the Y+ direction, is coupled to the second waveguide core 416_1 by a Y-branch structure 417_1, propagates in the X− direction, and is emitted from the end face of the optical waveguide.

As described above, the resin curing light 27 can be simultaneously emitted from two positions on the end face of the chip 21, and thus, the two positions can be simultaneously connected by a self-forming waveguide.

Note that, in this embodiment, emission from only two waveguide end faces is obtained. However, the branch structures and the crossover structure may be combined so that the resin curing light 27 can be emitted simultaneously from two or more waveguide end faces. This also allows simultaneous connection of a larger number of waveguides.

### Fifth Embodiment

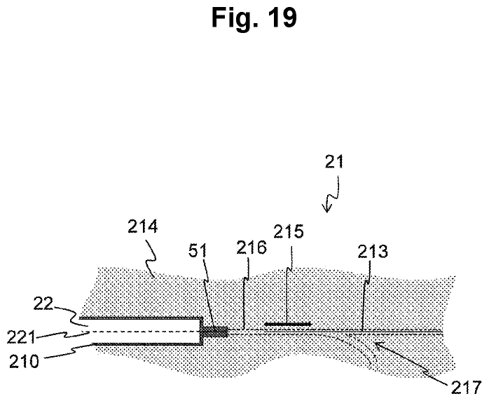

An optical connection structure according to a fifth embodiment of the present invention is described with reference to FIGS. 19 to 23.

### Configuration of an Optical Connection Structure 50

FIG. 19 shows a top perspective view of an optical connection structure 50 according to this embodiment. The optical connection structure 50 has a V-groove (hereinafter referred to as the “gap extension groove”) 51 that is continuous with the V-groove 210 for positioning an optical fiber and has a smaller width than the optical fiber.

When a tapered self-forming waveguide illustrated in FIG. 12 is manufactured, it is necessary to control the length of the gap. In a case where the mode field diameter of light is converted with the tapered waveguide of the self-forming waveguide, it is possible to adequately reduce the excessive loss at the time of the mode field diameter conversion by appropriately reducing the angle (hereinafter referred to as the “taper angle”) formed with the traveling direction of the tapered light.

The taper angle is determined by the core diameters of the optical fiber 22 and the waveguide (the second waveguide core 216) of the optical waveguide device 21, and the length of the gap. It is generally known that the core diameter of a self-forming waveguide is almost as large as the core diameter of the waveguide from which light is emitted. Accordingly, at the time of connection between different core diameters, it is possible to form a self-forming waveguide having a taper angle suitable for connecting the cores, by setting an optimum gap length.

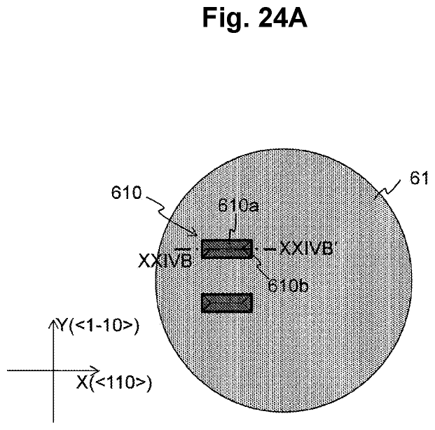

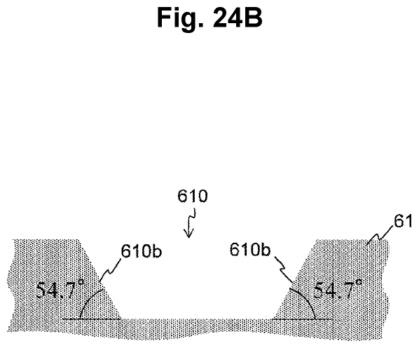

However, in a case where a V-groove that is a rectangular opening (see FIG. 24A, for example) is formed, it is difficult to control the length of the gap between the optical fiber core 221 and the end face of the chip 21, while matching the height of the core 221 of the optical fiber 22 with the height of the waveguide. This is because, in the case of a rectangular opening, both the height of the core 221 of the optical fiber 22 and the length of the gap are almost determined by the opening width 16 shown in FIG. 1B, as described below. Here, a “height” refers to a height from the edge line or the bottom surface of a V-groove bottom in a direction perpendicular to the surface of the Si substrate 211.

First, since the angle of the sloped etching surface A of the V-groove 210 subjected to anisotropic etching is constant (54.7°), the height of the core 221 at the center of the optical fiber 22 in the V-groove 210 is determined by the outer diameter of the optical fiber 22 and the opening width 16 of the V-groove 210, as can be seen from FIG. 1B.

Because the outer diameter of the general-purpose optical fiber is almost determined at this stage, the height of the core 221 of the optical fiber 22 is determined by the opening width 16 of the V-groove 210.

Further, as illustrated in FIG. 1A, when the optical fiber 22 is positioned by the V-groove 210, the tip of the optical fiber 22 is pushed until it comes into contact with the sloped etching surface B of the V-groove 210. The gap formed at this stage is determined by the height of the core 221 of the optical fiber 22 and the inclination angle of the sloped etching surface B of the V-groove 210. The height of the core 221 of the optical fiber 22 is determined by the opening width as described above, and the inclination angle of the sloped etching surface B of the V-groove 210 is constant (54.7°). Accordingly, the length of the gap between the optical fiber 22 and the waveguide end face in the chip 21 is also substantially determined by the opening width 16.

Since both the height of the core 221 of the optical fiber 22 and the length of the gap are determined by the opening width 16 as described above, it is difficult to control the gap while aligning the optical fiber core 221 and the optical waveguide 23 of the chip 21.

Therefore, to control the gap between waveguides while performing alignment in the height direction, the gap extension groove 51 that is continuous with an end face of the V-groove 210 for disposing the optical fiber 22 and has a smaller width than the V-groove 210 is formed in this embodiment.

As the gap extension groove 51 having a small width is provided as illustrated in FIG. 19, the length of the gap between the optical fiber 22 and the end face of the chip 21 can be extended in the longitudinal direction of the V-groove. It is possible to change the length of the gap by changing the layout of the mask for forming the V-groove, for example. Thus, a desired gap length can be obtained.

As described above, according to this embodiment, the length of the gap can be controlled as appropriate. Accordingly, the taper angle in the tapered self-forming waveguide can be reduced, and the excessive loss at the time of mode field diameter conversion can be reduced.

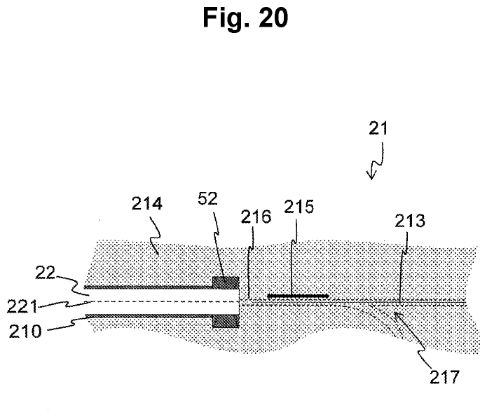

Note that, if a V-groove 52 having a greater opening width than the V-groove 210 for disposing the optical fiber 22 is used as illustrated in FIG. 20, the optical fiber 22 can enter the added groove, and therefore, the length of the gap cannot be controlled. In view of this, it is necessary to add a groove having a smaller opening width than the width of the V-groove 210 for disposing the optical fiber 22.

Note that this gap may be appropriately set in accordance with the purpose, such as the connection characteristics, the reliability, and the mechanical strength of the self-forming waveguide. For example, as for the connection between waveguides having an optical axis deviation by a self-forming waveguide, it is known that the effect of reducing connection loss with the axis deviation has gap dependency.

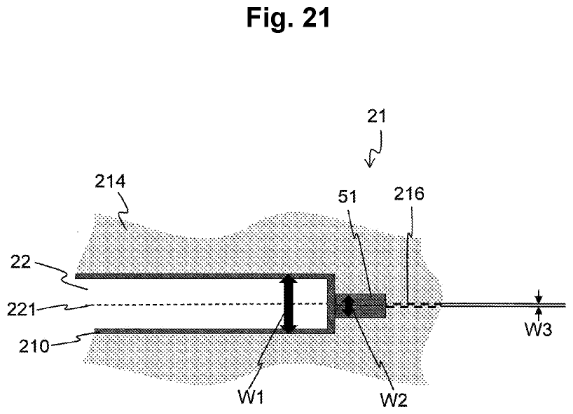

As illustrated in FIG. 21, if the width W2 of the gap extension groove 51 is smaller than the width W1 of the V-groove 210 for disposing the optical fiber 22, and is greater than the width W3 of the waveguide on the end face of the chip 21 (hereinafter referred to as the “width of the waveguide on the end face”), the effects to be achieved are the same as above, and the shape of the opening is not limited to any specific shape. Here, the width W3 of the waveguide on the end face is the mode field diameter of light on the end face of the chip.

When the width W3 is greater than the width W2 herein, a self-forming waveguide having a diameter substantially equal to the optical waveguide core diameter cannot be formed, since the width of the self-forming waveguide to be formed is substantially determined by the width 2. As a result, connection loss increases.

In a case where a self-forming waveguide is formed with this structure, drops of a photocurable resin are put into the gap extension groove 51 having a small width, to form the self-forming waveguide. Accordingly, the width of the self-forming waveguide is smaller than the width W1 of the V-groove 210 for disposing the optical fiber 22 and is greater than the width W3 of the waveguide on the end face of the chip 21, depending on the width of the gap extension groove 51. In practice, the width of the self-forming waveguide is formed so as to increase from the width W3 of the waveguide on the end face of the chip 21 to the width W1 of the V-groove 210 for disposing the optical fiber 22. Alternatively, the width of the self-forming waveguide can be made constant.

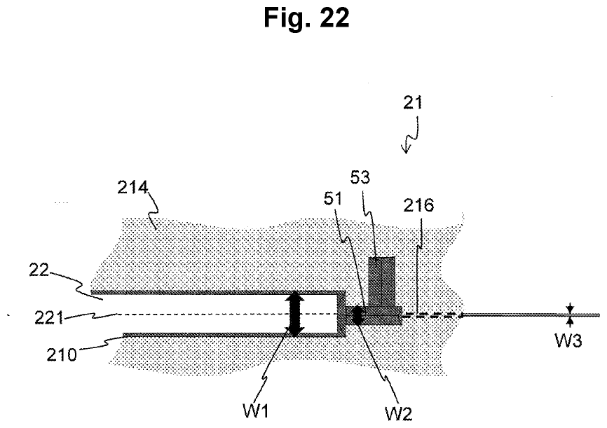

In a structure illustrated in FIG. 22, a groove portion (hereinafter referred to as the “flow path groove”) 53 is further provided on a side surface of the gap extension groove. As an example of formation of this flow path groove 53, a configuration in which the longitudinal direction thereof is a direction perpendicular to the longitudinal direction of the gap extension groove 51 is shown in the drawing. This groove portion can be used as the flow path for applying a resin, an uncured resin cleaning solution, or the like in the form of drops, thus resin drops can be easily applied from above the chip 21.

Note that, as long as the gap extension groove 51 and the flow path groove 53 each have a shape capable of securing a gap between the end faces of the optical fiber 22 and the chip 21, the same effects as above can be achieved in embodiments of the invention, regardless of the shape. For example, instead of V-grooves, grooves that can be formed by dry etching or the like may be used.

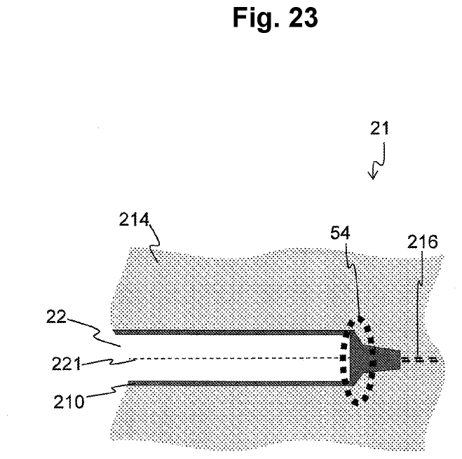

Further, as illustrated in FIG. 23, the shape 54 of the portion continuous with two V-grooves having different sizes may be a shape having a smooth continuous portion due to collapse of the crystal orientation of the surface subjected to etching, depending on the etching conditions such as the etching time. However, as long as a groove having a small opening width has a shape that can secure a gap between the waveguides and the optical fiber 22 as illustrated in FIG. 23, the same effects can be achieved, and its shape is not limited to any specific shape.

### Sixth Embodiment

An optical module 60 according to a sixth embodiment of the present invention is now described. The optical module 60 includes an optical connection structure according to the first to fifth embodiments, an optical circuit, and an electronic circuit. An optical signal that is input via the optical connection structure is optically processed by the optical circuit, is converted into an electrical signal by a photodiode in the electronic circuit, and is subjected to processing such as an arithmetic operation. Here, the optical module 60 may not include the optical circuit, and the optical connection structure may be connected directly to the electronic circuit. Also, in the optical module 60, the optical waveguide device of the optical connection structure, the optical circuit, and the electronic circuit can be integrated on the same substrate.

The materials that are used in the embodiments of the present invention are an example, and the present invention is not limited thereto. The material of a waveguide in an optical waveguide device may be a semiconductor such as InP or GaAs, a dielectric material, a resin, or the like, other than Si. For the second waveguide core, a resin material, a semiconductor, or the like may be used, instead of a dielectric material such as SiOx. Here, as long as the refractive index of the core (waveguide) covered by the second waveguide core is higher than the refractive index of the second waveguide core, and the material of the second waveguide core has a higher refractive index than the refractive index of the overcladding portion, this structure does not restrict the materials. Further, other than Si, a material such as SiC or glass may be used for the substrate. Here, the substrate may be any substrate in which V-grooves can be formed by etching.

The embodiments of the present invention show examples of the structures, dimensions, materials, and the like of the respective components in the configuration, manufacturing method, and the like regarding optical connection structures, but the present invention is not limited thereto. An optical connection structure is only required to exhibit its functions and achieve effects.

### INDUSTRIAL APPLICABILITY

Embodiments of the present invention relate to an optical connection structure that connects an optical fiber and a photonic device, an optical module, and a method for manufacturing the optical connection structure, and can be applied to devices and systems for optical communications and the like.

1.-11. (canceled)

12. An optical connection structure comprising:
an optical waveguide device comprising a substrate, a buried oxide layer, a first waveguide, and an overcladding sequentially arranged;
an optical fiber disposed in a V-groove in the substrate, wherein an end face of the optical fiber faces a first end face of the optical waveguide device such that a signal light emitted from the optical fiber enters the first waveguide;
a self-forming waveguide disposed between the first end face of the optical waveguide device and the end face of the optical fiber, wherein the self-forming waveguide comprises a portion made of an irradiation cured resin; and
a cladding disposed around the self-forming waveguide.

13. The optical connection structure according to claim 12, further comprising a silicon nitride on the overcladding.

14. The optical connection structure according to claim 12, further comprising a second waveguide core positioned to be optically coupled to the first waveguide, wherein directions in which light propagates in the first waveguide and the second waveguide core are substantially parallel to each other.

15. The optical connection structure according to claim 14, further comprising:
a resin-curing-light entering optical fiber disposed on the end face or a second end face of the optical waveguide device;
a coupling waveguide configured to receive a resin curing light from the resin-curing-light entering optical fiber; and
a branch structure to which the second waveguide core and the coupling waveguide are connected.

16. The optical connection structure according to claim 15, wherein the optical fiber and the resin-curing-light entering optical fiber are disposed on the first end face of the optical waveguide device, and wherein the optical connection structure further comprises an intrusion preventing groove between the optical fiber and the resin-curing-light entering optical fiber.

17. The optical connection structure according to claim 15, further comprising a plurality of the optical fibers, a plurality of the first waveguides, and a plurality of the second waveguide cores, wherein the coupling waveguide is branched and is connected to each of the second waveguide cores.

18. The optical connection structure according to claim 12, further comprising a gap extension groove in an end face of the V-groove in which the optical fiber is disposed, the gap extension groove having a width that is smaller than a width of the V-groove and is greater than a mode field diameter of light on the end face.

19. The optical connection structure according to claim 18, further comprising a flow path groove connected to the gap extension groove.

20. An optical module comprising:
an optical connection structure comprising:
an optical waveguide device comprising a substrate, a buried oxide layer, a first waveguide, and an overcladding sequentially arranged;
an optical fiber disposed in a V-groove in the substrate, wherein an end face of the optical fiber faces a first end face of the optical waveguide device such that a signal light emitted from the optical fiber enters the first waveguide;
a self-forming waveguide disposed between the first end face of the optical waveguide device and the end face of the optical fiber, wherein the self-forming waveguide comprises a portion made of an irradiation cured resin; and
a cladding disposed around the self-forming waveguide; and
an electronic circuit.

21. The optical module according to claim 20, further comprising a silicon nitride on the overcladding.

22. The optical module according to claim 20, further comprising a second waveguide core positioned to be optically coupled to the first waveguide, wherein directions in which light propagates in the first waveguide and the second waveguide core are substantially parallel to each other.

23. The optical connection structure according to claim 22, further comprising:
a resin-curing-light entering optical fiber disposed on the end face or a second end face of the optical waveguide device;
a coupling waveguide configured to receive a resin curing light from the resin-curing-light entering optical fiber; and
a branch structure to which the second waveguide core and the coupling waveguide are connected.

24. The optical connection structure according to claim 23, wherein the optical fiber and the resin-curing-light entering optical fiber are disposed on the first end face of the optical waveguide device, and wherein the optical connection structure further comprises an intrusion preventing groove between the optical fiber and the resin-curing-light entering optical fiber.

25. The optical connection structure according to claim 23, further comprising a plurality of the optical fibers, a plurality of the first waveguides, and a plurality of the second waveguide cores, wherein the coupling waveguide is branched and is connected to each of the second waveguide cores.

26. The optical connection structure according to claim 20, further comprising:
a gap extension groove in an end face of the V-groove in which the optical fiber is disposed, the gap extension groove having a width that is smaller than a width of the V-groove and is greater than a mode field diameter of light on the end face; and
a flow path groove connected to the gap extension groove.

27. A method for manufacturing an optical connection structure, the method comprising:
sequentially stacking a buried oxide layer and Si on a substrate;
processing the Si into a first waveguide;
forming an overcladding;
forming a V-groove in the substrate;
disposing a material of a self-forming waveguide on a first end face of an optical waveguide device;
disposing an optical fiber in the V-groove;
irradiating the material with resin curing light to form the self-forming waveguide; and
forming a cladding around the self-forming waveguide.

28. The method according to claim 27, further comprising forming a second waveguide core.

29. The method according to claim 27, further comprising a silicon nitride on the overcladding.

30. The method according to claim 27, further comprising forming a gap extension groove in an end face of the V-groove in which the optical fiber is disposed, the gap extension groove having a width that is smaller than a width of the V-groove and is greater than a mode field diameter of light on the end face.

31. The method according to claim 30, further comprising forming a flow path groove connected to the gap extension groove.
